(19) United States
(12) Patent Application Publication
(10) Pub. No.: US 2025/0190599 A1
(43) Pub. Date: Jun. 12, 2025

(54) ELECTRONIC DEVICE, AND METHOD FOR CONTROLLING ELECTRONIC DEVICE

(71) Applicant: Panasonic Intellectual Property Management Co., Ltd., Osaka (JP)

(72) Inventors: Yoshihiro KANEKO, Osaka (JP); Takuto NAITO, Kanagawa (JP); Misako MORIBE, Osaka (JP)

(73) Assignee: Panasonic Intellectual Property Management Co., Ltd., Osaka (JP)

(21) Appl. No.: 19/056,393

(22) Filed: Feb. 18, 2025

Related U.S. Application Data
(63) Continuation of application No. PCT/JP2023/029034, filed on Aug. 9, 2023.

(30) Foreign Application Priority Data
Sep. 1, 2022 (JP) 2022-139410

(51) Int. Cl. G06F 21/62

(52) U.S. Cl. CPC G06F 21/62; G06F 2221/2111

(57) ABSTRACT

An electronic device of the present disclosure includes a processor and a storage that stores an instruction to be executed by the processor, in which the instruction includes acquiring position information indicating a position of an electronic device, acquiring security setting information indicating a security setting determined according to the position of the electronic device, and controlling a function related to output of visual information of the electronic device based on the position information and the security setting information.

### TECHNICAL FIELD

The present disclosure relates to an electronic device and a method for controlling an electronic device.

### BACKGROUND ART

PTL 1 discloses an information processing apparatus that changes a presentation form of a document between a case where a possibility that a user having no browsing authority can browse the content of the document is high and a case where the possibility is low.

The information processing apparatus described in PTL 1 includes a display unit and a change unit. The display unit displays a document that can be opened by a user having browsing authority. The change unit changes the presentation form of the document between a case where the possibility that the user having no browsing authority can browse the content of the document is high and a case where the possibility is low, the possibility being calculated from the situation when the user is displaying the document.

### CITATION LIST

### Patent Literature

PTL 1: Unexamined Japanese Patent Publication No. 2020-52499

### SUMMARY OF THE INVENTION

### Technical Problem

The apparatus described in PTL 1 still has room for improvement in terms of improving security.

The present disclosure provides an electronic device and a method for controlling the electronic device that can improve security.

### Solution to Problem

An electronic device according to one aspect of the present disclosure includes:
a processor; and
a storage that stores an instruction to be executed by the processor, and
the instruction includes:
   acquiring position information indicating a position of an electronic device;
   acquiring security setting information indicating a security setting determined according to the position of the electronic device; and
   controlling a function related to output of visual information of the electronic device based on the position information and the security setting information.

A method for controlling an electronic device according to one aspect of the present disclosure includes:
acquiring position information indicating a position of an electronic device;
acquiring security setting information indicating a security setting determined according to the position of the electronic device; and
controlling a function related to output of visual information of the electronic device based on the position information and the security setting information.

### Advantageous Effect of Invention

According to the present disclosure, it is possible to provide an electronic device and a method for controlling the electronic device capable of improving security.

### BRIEF DESCRIPTION OF THE DRAWINGS

FIG. 1 is a schematic block diagram illustrating an example of a configuration of a control system including an electronic device according to a first exemplary embodiment of the present disclosure.

FIG. 2 is a control flowchart of an example of a method for controlling an electronic device according to the first exemplary embodiment of the present disclosure.

FIG. 3 is a flowchart of an example of processing of acquiring position information of an electronic device.

FIG. 4 is a flowchart of an example of processing of acquiring security setting information.

FIG. 5 is a flowchart of an example of processing of controlling a function related to output of visual information.

FIG. 6 is a schematic block diagram illustrating an example of a configuration of a control system including an electronic device according to a second exemplary embodiment of the present disclosure.

FIG. 7 is a flowchart of an example of processing of controlling a function related to output of visual information.

FIG. 8 is a schematic block diagram illustrating an example of a configuration of a control system including an electronic device according to a third exemplary embodiment of the present disclosure.

FIG. 9 is a control flowchart of an example of a method for controlling an electronic device according to the third exemplary embodiment of the present disclosure.

### DESCRIPTION OF EMBODIMENT

### Background to Present Disclosure

For example, in order to prevent the display information output to the display from being peeped by a third party, the electronic device has a function of filtering for display information.

However, since filtering for preventing peeping is manually set by a user, filtering does not work unless the user sets filtering. Therefore, even when the electronic device is used in a place where security is not ensured, the user may forget to turn on filtering function and filtering function may remain off. In addition, in a case where the user always keeps filtering on, the display information is difficult to see even in a place where security is ensured, and thus, usability is deteriorated.

In recent years, the number of users who work using an electronic device such as a laptop PC or a tablet PC at a place other than the office, for example, at home or at a client's place, for example, due to telework or a business trip has increased. For this reason, there is a demand for an electronic device capable of controlling a peeping prevention function by a third party to be turned on or off according to various places such as a place with high security or a place with low security.

Therefore, as a result of intensive studies, the present inventors have developed an electronic device that controls a function related to output of visual information according to a position where the electronic device is used, and have reached the present disclosure.

One exemplary embodiment of the present disclosure will now be described with reference to the accompanying drawings. Note that, the following description is merely exemplary in nature, and is not intended to limit the scope of, applications of, or use of the present disclosure. Moreover, the drawings are schematic representations, and the ratios between dimensions or the like do not necessarily match the actual dimensions.

Note that, the terms “first”, “second”, and the like used herein are only for the purpose of description, and should not be understood as explicitly or implicitly indicating relative importance or a priority of technical features. Features limited to “first” and “second” are intended to explicitly or implicitly indicate the inclusion of one or more such features.

### First Exemplary Embodiment

### [General Configuration]

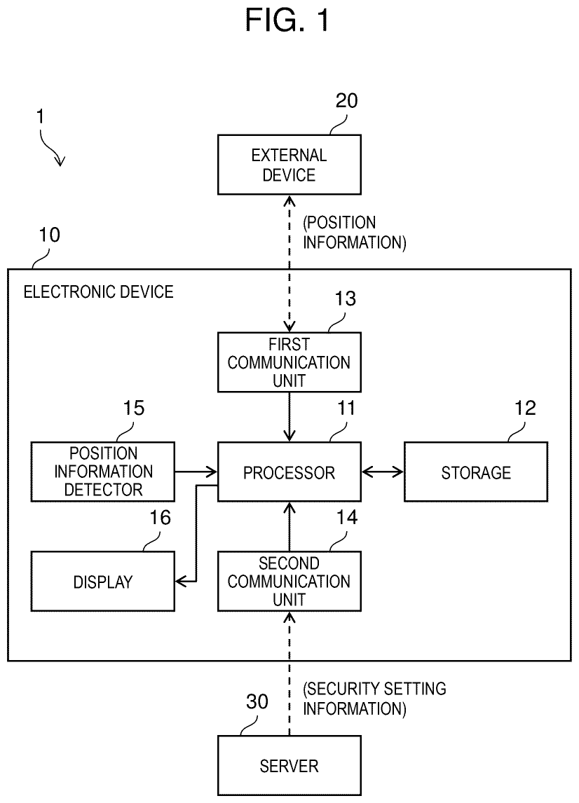

FIG. 1 is a schematic block diagram illustrating a configuration of control system 1 including electronic device 10 according to a first exemplary embodiment of the present disclosure. As illustrated in FIG. 1, in control system 1, electronic device 10 and external device 20 perform near field communication. In addition, electronic device 10 and server 30 communicate with each other via a network.

### <Electronic Device>

Electronic device 10 is, for example, a laptop PC. Electronic device 10 includes processor 11, storage 12, first communication unit 13, second communication unit 14, position information detector 15, and display 16.

Processor 11 controls each component of electronic device 10. Processor 11 reads data, an instruction, or a program stored in storage 12 and performs various arithmetic processing to implement a predetermined function. For example, processor 11 can be implemented by a circuit including a semiconductor element and the like. Processor 11 can be formed of, for example, a microcomputer, a CPU, an MPU, a GPU, a DSP, an FPGA, and an ASIC.

Storage 12 stores an instruction executed by processor 11. Storage 12 is a storage medium that stores a command, a program, or data necessary for implementing a function of electronic device 10. Storage 12 can be implemented by, for example, RAM, ROM, PROM, PROM, EPROM, flash memory, HDD, SSD, or a combination thereof.

First communication unit 13 performs near field communication with external device 20. The near field communication means, for example, wireless communication within several meters. For example, the near field communication may be wireless communication within 50 m, preferably wireless communication within 10 m, and more preferably wireless communication within 5 m. First communication unit 13 includes a circuit that performs near field communication with external device 20 in conformity with a predetermined communication standard. The predetermined communication standard includes, for example, Bluetooth (registered trademark).

Second communication unit 14 communicates with server 30 via the network. Second communication unit 14 includes a circuit that communicates with server 30 via a wireless or wired network in conformity with a predetermined communication standard. For example, electronic device 10 includes a circuit that can perform communication in conformity with a standard such as a local area network (LAN), a wide area network (WAN), Wi-Fi (registered trademark), a wireless wide area network (WWAN), or a wireless local area network (WLAN).

Position information detector 15 detects the position of electronic device 10. Position information detector 15 includes, for example, a global positioning system (GPS). Position information includes, for example, latitude and longitude.

Display 16 is a screen of electronic device 10, and outputs display information. Display 16 may be, for example, a liquid crystal display, a touch panel display, or the like. Display 16 is built in electronic device 10.

### <External Device>

External device 20 performs near field communication with electronic device 10. External device 20 may be, for example, a mobile terminal that can be carried by a user, such as a smartphone or a tablet PC. Alternatively, external device 20 may be an information processing apparatus installed at a predetermined place.

For example, external device 20 includes a processor and a storage that stores a program executed by the processor. In external device 20, the processor controls each component of external device 20. The processor reads data, an instruction, or a program stored in the storage and performs various arithmetic processing to implement a predetermined function. For example, in external device 20, the processor can be implemented by a circuit including a semiconductor element and the like. The processor can be formed of, for example, a microcomputer, a CPU, an MPU, a GPU, a DSP, an FPGA, and an ASIC. The storage can be implemented by, for example, RAM, ROM, PROM, PROM, EPROM, flash memory, HDD, SSD, or a combination thereof.

External device 20 includes a communication circuit that performs near field communication with electronic device 10 in conformity with a predetermined communication standard. In addition, external device 20 includes a sensor that detects the position of external device 20. The sensor is, for example, the GPS. In the present exemplary embodiment, the sensor of external device 20 can detect the position with higher accuracy than position information detector 15 of electronic device 10.

External device 20 transmits the position information acquired by external device 20 to electronic device 10 by performing near field communication with electronic device 10.

### <Server>

Server 30 communicates with electronic device 10 via the network. Server 30 is an information processing apparatus connectable to the network.

For example, server 30 includes the processor and the storage that stores a program executed by the processor. In server 30, the processor controls each component of server 30. The processor reads data, an instruction, or a program stored in the storage and performs various arithmetic processing to implement a predetermined function. For example, in server 30, the processor can be implemented by a circuit including a semiconductor element and the like. The processor can be formed of, for example, a microcomputer, a CPU, an MPU, a GPU, a DSP, an FPGA, and an ASIC. The storage can be implemented by, for example, RAM, ROM, PROM, PROM, EPROM, flash memory, HDD, SSD, or a combination thereof.

Server 30 stores security setting information indicating security setting determined according to the position of electronic device 10 in the storage.

The security setting information includes information of a setting of a function related to output of visual information of the electronic device according to the position. In the present exemplary embodiment, the function related to the output of the visual information is a function of controlling display information output to display 16.

For example, the function of controlling the display information output to display 16 includes a filtering function for preventing peeping by a third party. For example, filtering function is a function of applying an electronic filter that makes the display information output to the display less visible. For example, the filter may reduce the brightness of display 16 to make the display information less visible. Alternatively, filtering may make the displayed information less visible by changing the viewing angle of the display. Filtering may make the displayed information less visible in any manner.

For example, the security setting information includes a registered position indicating a position registered in advance and the security setting set for the registered position. For example, the security setting information may be a table indicating a position and the security setting corresponding to the position. The security setting includes, for example, setting of on or off control of filtering.

For example, in the security setting information, filtering is set to off for the position where security is ensured. On the other hand, filtering is set to on for the position where security is not ensured.

In the present exemplary embodiment, the registered position is, for example, a position where security can be ensured, such as a workplace or a co-working space. Therefore, in the security setting information, filtering is set to off for the registered position. In addition, filtering is set to on for an unregistered position other than the registered position.

The security setting information can be set, changed, or updated, for example, by an administrator of server 30.

Server 30 includes a circuit that communicates with electronic device 10 via a wireless or wired network in conformity with a predetermined communication standard. Server 30 transmits the security setting information stored in the storage to electronic device 10.

### [Operation]

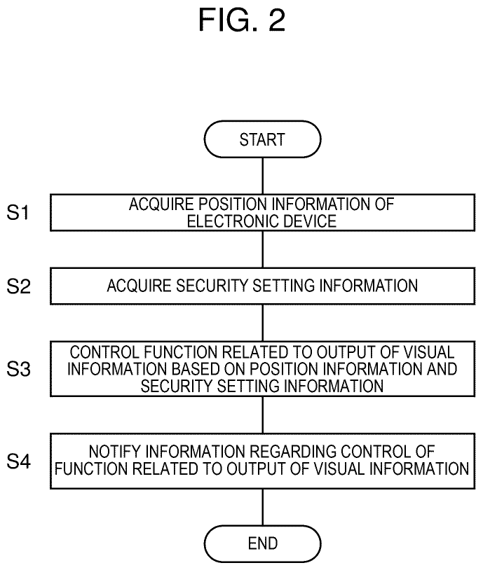

An operation of electronic device 10, that is, an example of a method for controlling electronic device 10 will be described with reference to FIG. 2 to FIG. 5.

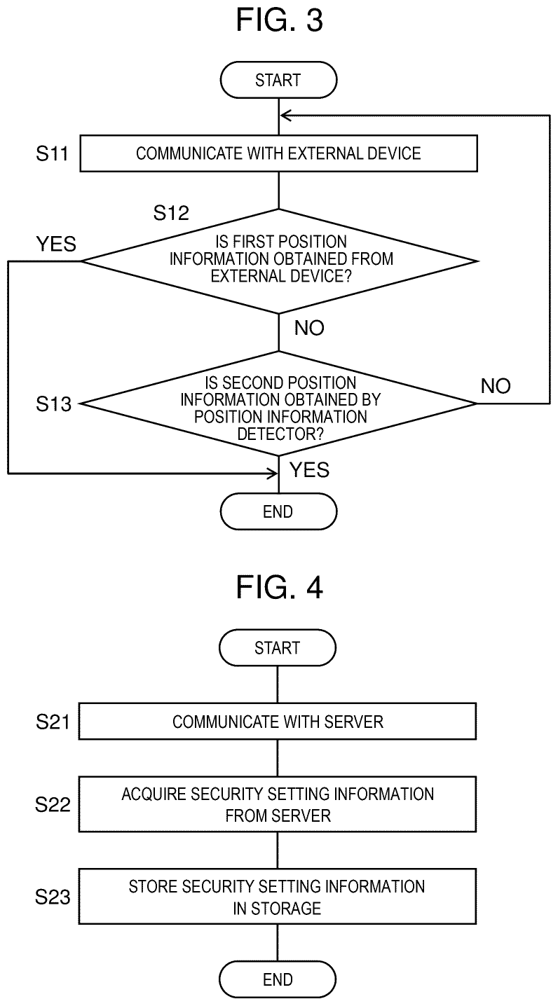

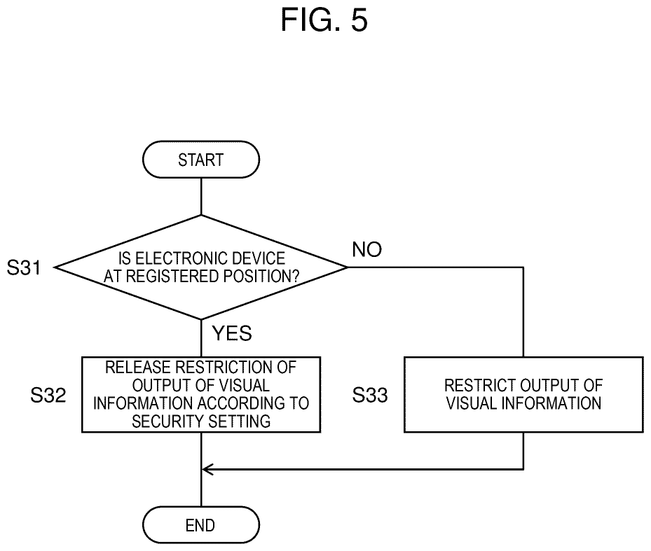

FIG. 2 illustrates a control flowchart of an example of a method for controlling electronic device 10 according to the first exemplary embodiment of the present disclosure. FIG. 3 illustrates a flowchart of an example of processing of acquiring position information of electronic device 10. FIG. 4 illustrates a flowchart of an example of processing of acquiring security setting information. FIG. 5 illustrates a flowchart of an example of processing of controlling the function related to the output of the visual information.

As illustrated in FIG. 2, in step S1, electronic device 10 acquires the position information of electronic device 10. As illustrated in FIG. 3, step S1 includes steps S11 to S13.

In step S11, electronic device 10 communicates with external device 20. Electronic device 10 acquires the position information acquired by external device 20 by performing near field communication with external device 20. In the present specification, the position information acquired by external device 20 is referred to as “first position information”.

Specifically, external device 20 acquires the first position information by the sensor of external device 20. External device 20 transmits the first position information to electronic device 10. Electronic device 10 receives the first position information from external device 20 by first communication unit 13.

In step S12, electronic device 10 determines whether or not the first position information is acquired from external device 20.

In a case where it is determined in step S12 that electronic device 10 has acquired the first position information, the processing of acquiring the position information ends. In this case, electronic device 10 determines that the position indicated by the first position information is the position where electronic device 10 is used.

In a case where it is determined in step S12 that electronic device 10 has not acquired the first position information, the processing proceeds to step S13. For example, in a case where electronic device 10 cannot communicate with external device 20 or can communicate with external device 20 but cannot receive the first position information, it is determined that the first position information is not acquired from external device 20.

Note that, in step S12, in a case where electronic device 10 has not been able to acquire the first position information for a predetermined period, the processing may proceed to step S13. Alternatively, in a case where electronic device 10 has not been able to acquire the first position information a predetermined number of times, the processing may proceed to step S13.

In step S13, electronic device 10 determines whether or not the position information of electronic device 10 has been acquired using position information detector 15 of electronic device 10. In the present specification, the position information acquired by position information detector 15 of electronic device 10 is referred to as “second position information”.

In a case where it is determined in step S13 that electronic device 10 has acquired the second position information using position information detector 15, the processing of acquiring the position information ends. In this case, electronic device 10 determines that the position indicated by the second position information is the position where electronic device 10 is used.

In a case where it is determined in step 13 that electronic device 10 has not acquired the second position information using position information detector 15, the processing returns to step S11.

As described above, in step S1, electronic device 10 acquires the position information indicating the position of electronic device 10 by performing steps S11 to S13.

Returning to FIG. 2, in step S2, electronic device 10 acquires the security setting information. The security setting information is information indicating the security setting determined according to the position of electronic device 10. In the present exemplary embodiment, the security setting information includes a registered position indicating a position registered in advance, and a security setting set for the registered position.

Electronic device 10 stores the security setting information in storage 12. Therefore, in step S2, electronic device 10 may acquire the security setting information by reading the security setting information from storage 12.

The security setting information is set, changed, or updated by the administrator. Electronic device 10 can set, change, or update the security setting information stored in storage 12 of electronic device 10 by acquiring the latest security setting information from server 30.

Processing of setting, changing, or updating the security setting information stored in storage 12 of electronic device 10 will be described with reference to FIG. 4.

As illustrated in FIG. 4, in step S21, electronic device 10 communicates with server 30. Electronic device 10 communicates with server 30 via the network by second communication unit 14.

In step S22, electronic device 10 acquires the security setting information from server 30. Server 30 stores the security setting information set, changed, or updated by the administrator in the storage. Server 30 transmits the security setting information to electronic device 10 via the network. Electronic device 10 receives the security setting information from server 30 via the network by second communication unit 14.

In step S23, electronic device 10 stores the security setting information in storage 12.

As described above, by performing steps S21 to S23, electronic device 10 can acquire the latest security setting information and store the acquired security setting information in storage 12. Note that, steps S21 to S23 may be automatically performed at a predetermined time, or may be performed by a user's operation.

Returning to FIG. 2, in step S3, electronic device 10 controls the function related to the output of the visual information of electronic device 10 based on the position information and the security setting information of electronic device 10. As illustrated in FIG. 5, step S3 includes steps S31 to S32.

In step S31, it is determined whether or not electronic device 10 is at the registered position. Electronic device 10 determines whether or not electronic device 10 is at the registered position using the position information of electronic device 10 acquired in step S1 and the security setting information acquired in step S2.

Specifically, electronic device 10 determines whether or not the position indicated by the position information of electronic device 10 acquired in step S1 is at the registered position registered in the security setting information. For example, electronic device 10 compares the position indicated by the position information with the registered position included in the security setting information. In a case where the position indicated by the position information matches the registered position, or in a case where the position indicated by the position information is within a predetermined range from the registered position, it is determined that electronic device 10 is at the registered position. The predetermined range can be arbitrarily set. For example, the predetermined range may be set in a facility, a land, or a place indicated by the registered position, or may be set in a room, a land, or a part of a place in the facility.

In a case where it is determined in step S31 that electronic device 10 is at the registered position, the processing proceeds to step S32. In a case where it is determined that electronic device 10 is not at the registered position, that is, electronic device 10 is at the unregistered position, the processing proceeds to step S33.

In step S32, electronic device 10 releases the restriction of the output of the visual information according to the security setting set for the registered position. Electronic device 10 releases the restriction of the output of the visual information according to the security setting set for the registered position determined in step S31 based on the security setting information.

In the present exemplary embodiment, the control of the output of the visual information is control of on or off of filtering for the display information output to display 16, and the registered position is a workplace or the like where security is ensured. Therefore, in the security setting information, filtering is set to off for the registered position.

In step S32, in a case where electronic device 10 is at the registered position, the electronic device controls filtering to be turned off according to the security setting of the security setting information. As a result, filtering can be automatically turned off in a place where security is ensured, and usability is improved for the user.

In step S33, electronic device 10 restricts the output of the visual information in a case where the electronic device is at the unregistered position. Electronic device 10 controls filtering for the display information output to display 16 to be turned on. As a result, filtering is automatically turned on in a place where security is not ensured, so that peeping by a third party can be prevented even when the user does not manually set filtering, and thus, security can be improved.

As described above, in step S3, implementation of steps S31 to S33 allows the function of controlling on or off of filtering for the display information output to display 16 to be controlled according to the position of electronic device 10 as the function related to the output of the visual information.

Returning to FIG. 2, in step S4, electronic device 10 notifies information regarding control of the function related to the output of the visual information. For example, electronic device 10 displays a notification indicating that filtering is turned on or off on display 16 of electronic device 10. The notification includes, for example, a pop-up display. Alternatively, electronic device 10 outputs, from the speaker, a voice notifying that filtering has been turned on or off.

### [Effects]

According to electronic device 10 of the first exemplary embodiment, the following effects can be obtained.

Electronic device 10 includes processor 11 and storage 12 that stores an instruction executed by processor 11. The instruction includes steps S1 to S3. In step S1, electronic device 10 acquires position information indicating the position of electronic device 10. In step S2, electronic device 10 acquires the security setting information indicating the security setting determined according to the position of electronic device 10. In step S3, electronic device 10 controls the function related to the output of the visual information of electronic device 10 based on the position information and the security setting information.

With such a configuration, it is possible to control the function related to the output of the visual information according to the position of electronic device 10, and thus, it is possible to improve security. For example, in a case where electronic device 10 is at a relatively high security position, electronic device 10 does not restrict the function related to the output of the visual information. On the other hand, in a case where electronic device 10 is at a relatively low security position, electronic device 10 restricts the function related to the output of the visual information. As described above, since the function related to the output of the visual information can be automatically controlled according to the position of electronic device 10, it is possible to improve security without deteriorating usability for the user. For example, as compared with a case where the user manually sets on or off of the function, it is possible to reliably restrict the function related to the output of the visual information in a place where security is not ensured.

In addition, when electronic device 10 is at a relatively high security position, the restriction of the function related to the output of the visual information is automatically released, so that power consumption caused by the function can be suppressed.

Step S3 of controlling the function related to the output of the visual information includes controlling on or off of filtering for the display information output to the screen of electronic device 10. With such a configuration, it is possible to prevent a third party from viewing the display information displayed on the screen of electronic device 10, and thus, it is possible to improve security.

For example, the information leakage risk can be reduced by setting filtering to off at the registered position registered in advance such as a company or home and forcibly setting filtering to on at a position other than the registered position. In addition, the work efficiency of the user can be improved by enhanced visibility and convenience of the user.

The security setting information includes the registered position indicating a position registered in advance and the security setting set for the registered position. Step S3 of controlling the function related to the output of the visual information includes determining whether or not electronic device 10 is at the registered position and restricting the output of the visual information according to the security setting in accordance with the determination result of whether or not electronic device 10 is at the registered position. With such a configuration, it is possible to restrict the function related to the output of the visual information according to whether or not electronic device 10 is at the registered position, and thus, it is possible to improve security while suppressing deterioration in usability.

Restricting the output of the visual information according to the security setting includes turning on filtering for the display information output to the screen of electronic device 10. With such a configuration, in a place where security is not ensured, it is possible to prevent a third party from viewing the display information displayed on the screen of electronic device 10, and thus, it is possible to improve security.

Step S3 of controlling the function related to the output of the visual information includes turning off filtering for the display information output to the screen of electronic device 10 in accordance with the determination result of whether or not electronic device 10 is at the registered position. With such a configuration, filtering can be turned off according to whether or not electronic device 10 is at the registered position. As a result, in a place where security is ensured, filtering can be turned off to improve usability. In addition, power consumption due to filtering can be reduced.

Electronic device 10 includes first communication unit 13 that communicates with external device 20 that acquires position information. Step S1 of acquiring the position information includes acquiring the position information from external device 20 by first communication unit 13. With such a configuration, based on the position information acquired by external device 20, the position information of electronic device 10 can be acquired. In addition, in a case where external device 20 is a device including the GPS with higher accuracy than position information detector 15 of electronic device 10, for example, a smartphone, electronic device 10 can acquire position information with higher accuracy.

Electronic device 10 includes position information detector 15 that acquires position information of electronic device 10. Step S1 of acquiring the position information includes acquiring the position information by position information detector 15. With such a configuration, electronic device 10 can acquire the position information by electronic device 10 alone without depending on external device 20. As a result, convenience can be improved.

The security setting information is stored in server 30 on the network. Electronic device 10 includes second communication unit 14 that communicates with server 30 via the network. The instruction includes steps S21 to S23 of acquiring the security setting information from server 30 by second communication unit 14. With such a configuration, electronic device 10 can acquire the security setting information from server 30. For example, in a case where the administrator sets, changes, or updates the security setting information stored in server 30, electronic device 10 can acquire the latest set, changed, or updated security setting information by communicating with server 30.

The instruction includes step S4 of notifying information regarding control of the function related to the output of the visual information. With such a configuration, it is possible to notify the user of the restriction or the restriction release of the function related to the output of the visual information. As a result, the usability can be improved.

Also in the control method, the program, and the computer storage medium of electronic device 10, effects similar to the above effects can be obtained.

Note that, in the present exemplary embodiment, an example has been described in which electronic device 10 is a laptop PC, but the present invention is not limited thereto. For example, electronic device 10 may be a computer such as a desktop PC or a tablet PC.

In the present exemplary embodiment, an example has been described in which first communication unit 13 and second communication unit 14 are separate bodies, but the present invention is not limited thereto. For example, first communication unit 13 and second communication unit 14 may be integrally configured.

In the present exemplary embodiment, an example has been described in which external device 20 is a smartphone, but the present invention is not limited thereto. In addition, an example has been described in which external device 20 performs near field communication with electronic device 10, but the present invention is not limited thereto. For example, external device 20 only needs to be able to perform short-distance communication with electronic device 10, and may communicate with electronic device 10 by wired communication. For example, external device 20 may be a beacon. The beacon may be fixed to a specific place, for example, a conference room or the like. In this case, electronic device 10 may not include position information detector 15 such as the GPS. Electronic device 10 may detect that electronic device 10 is at a relatively high security position by communicating with the beacon.

In the present exemplary embodiment, an example has been described in which the sensor of external device 20 can detect the position with higher accuracy than position information detector 15 of electronic device 10, but the present invention is not limited thereto. For example, the sensor of external device 20 may have lower accuracy in position detection than position information detector 15 of electronic device 10. For example, electronic device 10 may use the position information with higher position detection accuracy out of the sensor of external device 20 and position information detector 15.

In the present exemplary embodiment, an example has been described in which step S1 of acquiring the position information includes acquiring the first position information from external device 20 and acquiring the second position information by position information detector 15 of electronic device 10, but the present invention is not limited thereto. For example, in step S1, the position information may be acquired from at least one of external device 20 or position information detector 15. For example, electronic device 10 may not include position information detector 15. In this case, electronic device 10 may acquire the first position information from external device 20 and may not acquire the second position information. Alternatively, electronic device 10 may not include first communication unit 13. In this case, electronic device 10 may acquire the second position information by position information detector 15, and may not acquire the first position information by communicating with external device 20.

In the present exemplary embodiment, an example has been described in which the position information of electronic device 10 is acquired by the GPS, but the present invention is not limited thereto. For example, the position information of electronic device 10 may be acquired from an IP address, a beacon, or the like. In this case, position information detector 15 may include a circuit that specifies the position from an IP address, a beacon, or the like.

In the present exemplary embodiment, an example has been described in which step S2 of acquiring the security setting information reads the security setting information stored in storage 12, but the present invention is not limited thereto. For example, in step S2, the security setting information may be directly acquired from server 30.

In the present exemplary embodiment, an example has been described in which the set, changed, or updated security setting information is acquired from server 30, but the present invention is not limited thereto. For example, the set, changed, or updated security setting information may be stored in a computer-readable storage medium. When being connected to a computer-readable storage medium, electronic device 10 may read the security setting information from the computer-readable storage medium and store the security setting information in storage 12. In this case, electronic device 10 may not communicate with server 30.

In the present exemplary embodiment, an example has been described in which the security setting information includes the registered position and the security setting set for the registered position, but the present invention is not limited thereto. For example, the security setting may be set for each of a plurality of the registered positions.

In the present exemplary embodiment, an example has been described in which a position where security is ensured is registered as the registered position, but the present invention is not limited thereto. For example, a position with relatively low security may be registered as the registered position.

For example, a specific place where security is not ensured may be registered, and in a case where electronic device 10 is in the specific place, the function related to the output of the visual information may be restricted. For example, in a case where electronic device 10 is in a specific place, electronic device 10 may control filtering to be turned on. In addition, in a case where electronic device 10 is not in the specific place, electronic device 10 may control filtering to be turned off.

In the present exemplary embodiment, an example has been described in which the function related to the output of the visual information is the control of on or off of filtering for the display information output to display 16, but the present invention is not limited thereto. For example, the function related to the output of the visual information may be the control of on or off of the output of the display information to an external output device. In a case where electronic device 10 includes a human sensor and restricts a function based on detection information by the human sensor, the function related to the output of the visual information may be acquisition of the detection information by the human sensor. Alternatively, in a case where a function is restricted on a condition of a specific time zone when electronic device 10 accesses a specific place, a specific file, or server 30, the function related to the output of the visual information may be detection of access to a specific place, a specific file, or server 30, or timing of a specific time zone.

### Second Exemplary Embodiment

An electronic device according to a second exemplary embodiment of the present disclosure will be described. The second exemplary embodiment will be described mainly on the points different from the first exemplary embodiment. In the description of the second exemplary embodiment, a configuration identical or equivalent to that of the first exemplary embodiment will be denoted by the same reference mark. In addition, the description already given for the first exemplary embodiment is omitted for the second exemplary embodiment.

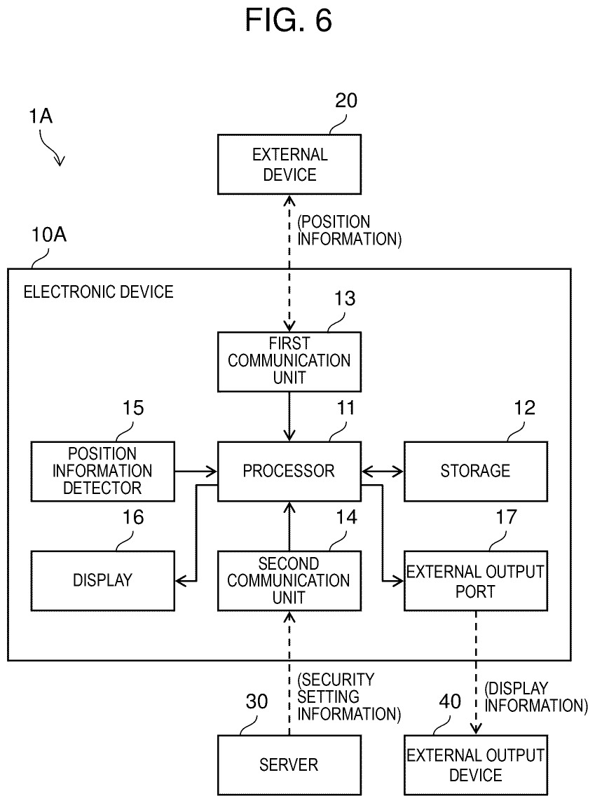

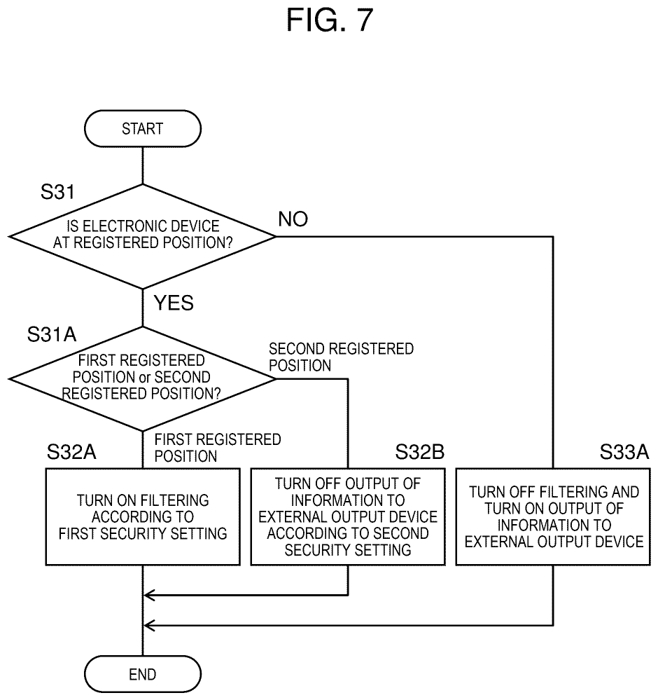

An example of an electronic device according to the second exemplary embodiment will be described with reference to FIG. 6 to FIG. 7. FIG. 6 is a schematic block diagram illustrating an example of a configuration of control system 1A including electronic device 10A according to the second exemplary embodiment of the present disclosure. FIG. 7 illustrates a flowchart of an example of processing of controlling a function related to output of visual information.

The second exemplary embodiment is different from the first exemplary embodiment in that electronic device 10A includes external output port 17 and outputs display information to external output device 40 via external output port 17, and that control of output of visual information includes control of output of display information to external output device 40.

As illustrated in FIG. 6, electronic device 10A includes external output port 17.

External output port 17 is a port that outputs display information as visual information to external output device 40. External output port 17 includes, for example, a port capable of outputting display information such as HDMI (registered trademark), RGB, or USB (registered trademark).

External output device 40 is connected to electronic device 10, acquires display information from electronic device 10, and outputs the display information. External output device 40 is a device capable of outputting the display information separately from electronic device 10, and is, for example, an external display. External output device 40 is connected to external output port 17 of electronic device 10 in a wired or wireless manner. For example, external output device 40 is connected to external output port 17 via an HDMI (registered trademark) cable, an RGB cable, a USB (registered trademark) cable, or the like.

An example of a method for controlling electronic device 10A will be described with reference to FIG. 7. Note that, in the example illustrated in FIG. 7, the security setting information includes a first registered position, a second registered position, a first security setting set for the first registered position, and a second security setting set for the second registered position.

In addition, in the example illustrated in FIG. 7, positions with relatively low security are registered as the first registered position and the second registered position. Therefore, the first security setting sets filtering for visual information to on, and the second security setting sets the output of the visual information to external output device 40 to off.

In addition, in FIG. 7, step S31 in the second exemplary embodiment is the same as step S31 in the first exemplary embodiment, and thus, a detailed description thereof is omitted.

As illustrated in FIG. 7, in step S31, electronic device 10A determines whether or not electronic device 10A is at the registered position. In step 31, in a case where electronic device 10A is at the registered position, the processing proceeds to step S31A. In a case where electronic device 10A is not at the registered position, the processing proceeds to step S33A.

In step S31A, electronic device 10A determines whether electronic device 10A is at the first registered position or the second registered position. In a case where electronic device 10 is at the first registered position, the processing proceeds to step S32A. In a case where electronic device 10A is at the second registered position, the processing proceeds to step S32B.

In step S32A, electronic device 10A controls filtering for the visual information to be turned on according to the first security setting.

In step S32B, electronic device 10A controls the output of the visual information to external output device 40 to be turned off according to the second security setting. In the present exemplary embodiment, electronic device 10 controls external output port 17 to be turned off in order to turn off the output of the display information to external output device 40. As a result, the output of the display information to external output device 40 is stopped.

In step S33A, electronic device 10A controls filtering to be turned off and controls output of information to external output device 40 to be turned on. In the present exemplary embodiment, electronic device 10 controls external output port 17 to be turned on in order to turn on the output of the display information to external output device 40. As a result, the display information can be output to external output device 40.

### [Effects]

According to electronic device 10A of the second exemplary embodiment, the following effects can be obtained.

In electronic device 10A, controlling the function related to the output of the visual information includes at least one of controlling on or off of filtering for the display information output to the screen of electronic device 10A or controlling on or off of the output of the display information to external output device 40 connected to electronic device 10A. With such a configuration, when electronic device 10A is connected to external output device 40, on or off of the output of the display information to external output device 40 can be controlled according to the position of electronic device 10A. As a result, security can be further improved.

Note that, in the second exemplary embodiment, an example has been described in which the first security setting is on setting of filtering, and the second security setting is off setting of the display information output to external output device 40. However, the present invention is not limited thereto. For example, the first security setting may be off setting of the display information output to external output device 40. Alternatively, in the second security setting, both on setting of filtering and off setting of the display information output to external output device 40 may be set.

In addition, the first security setting may be off setting of filtering and on setting of the output to external output device 40. In a case where electronic device 10A is at the unregistered position, filtering may be controlled to be turned on, and the output of the display information to external output device 40 may be controlled to be turned off.

In the second exemplary embodiment, an example has been described in which external output port 17 and external output device 40 are connected by the cable, but the present invention is not limited thereto. For example, external output port 17 may include a communication port capable of outputting wireless video, and may be wirelessly connected to external output device 40. The communication port may be included in first communication unit 13 or second communication unit 14.

### Third Exemplary Embodiment

An electronic device according to a third exemplary embodiment of the present disclosure will be described. The third exemplary embodiment will be described mainly on the points different from the first exemplary embodiment. In the description of the third exemplary embodiment, a configuration identical or equivalent to that of the first exemplary embodiment will be denoted by the same reference mark. In addition, the description already given for the first exemplary embodiment is omitted for the third exemplary embodiment.

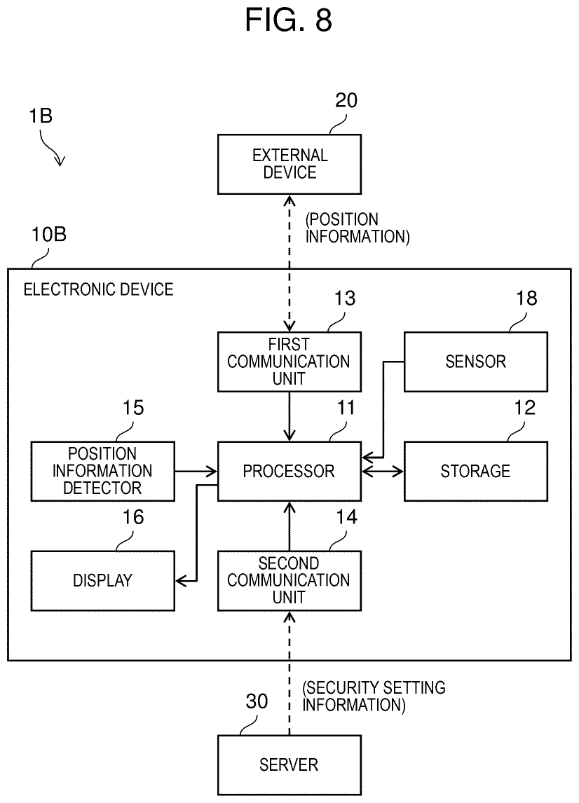

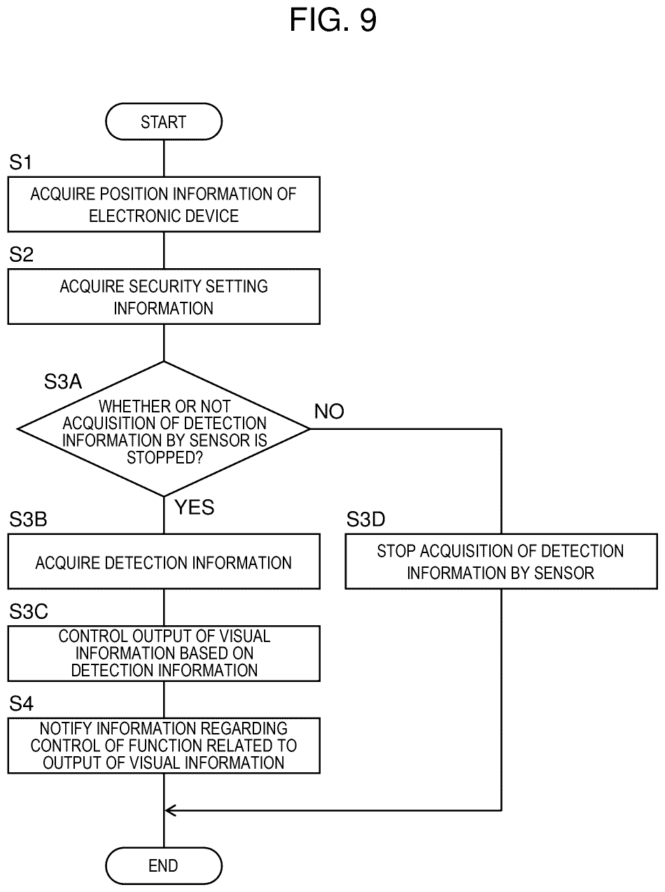

An example of the electronic device according to the third exemplary embodiment will be described with reference to FIG. 8 to FIG. 9. FIG. 8 is a schematic block diagram illustrating an example of a configuration of control system 1B including electronic device 10B according to the third exemplary embodiment of the present disclosure. FIG. 9 is a control flowchart of an example of a method for controlling electronic device 10B according to the third exemplary embodiment of the present disclosure.

The third exemplary embodiment is different from the first exemplary embodiment in that electronic device 10B includes sensor 18 that acquires detection information for detecting the presence of a person, and that output of visual information is controlled based on the detection information. In addition, the third embodiment is different from the first exemplary embodiment in that acquisition of detection information by sensor 18 is stopped according to the position of electronic device 10B as an example of controlling the function related to the output of the visual information.

As illustrated in FIG. 8, electronic device 10B includes sensor 18 that acquires the detection information for detecting the presence of a person. Sensor 18 detects, for example, an image around electronic device 10, a sound, a distance to a detection target, or the like as the detection information. For example, sensor 18 may be a camera, a microphone, a proximity sensor, an infrared sensor, or an ultrasonic sensor. In addition, sensor 18 is not limited to these devices, and may be any device that can detect the presence of a person.

An example of a method for controlling electronic device 10B will be described with reference to FIG. 9. Note that, steps S1, S2, and S4 of the third exemplary embodiment are similar to steps S1, S2, and S4 of the first exemplary embodiment, and thus, description thereof is omitted.

As illustrated in FIG. 9, in step S3A, electronic device 10 determines whether or not acquisition of detection information by sensor 18 is stopped based on position information and security setting information of electronic device 10.

For example, in step S3A, electronic device 10B determines whether or not electronic device 10B is at the registered position. In a case where electronic device 10B is at the registered position, electronic device 10B determines to stop the acquisition of detection information by sensor 18. In a case where electronic device 10B is not at the registered position, electronic device 10B does not stop the acquisition of detection information by sensor 18.

In a case where it is determined in step S3A that the acquisition of detection information by sensor 18 is not to be stopped, the processing proceeds to S3B. In a case where it is determined that the acquisition of detection information by sensor 18 is to be stopped, the processing proceeds to S3D.

In step S3B, electronic device 10B acquires the detection information by sensor 18.

In step S3C, electronic device 10B controls the output of the visual information based on the detection information. Electronic device 10B controls on or off of filtering for display information output to display 16 as control of the output of the visual information.

For example, electronic device 10B determines whether or not there is a person around electronic device 10B based on the detection information. In a case where it is determined that there is a person around electronic device 10B, electronic device 10B sets filtering for the display information output to display 16 to on. In a case where it is determined that there is no person around electronic device 10B, electronic device 10B sets filtering for the display information output to display 16 to off.

In step S3D, electronic device 10B stops the acquisition of detection information by sensor 18. Stopping the acquisition of detection information by sensor 18 means stopping a detection function on software. That is, sensor 18 operates on the hardware, and the detection function on the software is turned off. For example, in a case where sensor 18 is a camera, a function as a camera can be used, but the detection function for detecting the presence of a person is turned off.

### [Effects]

According to electronic device 10B of the third exemplary embodiment, the following effects can be obtained.

Electronic device 10B further includes sensor 18 that acquires the detection information for detecting the presence of a person. The instruction executed by processor 11 further includes acquiring, by sensor 18, the detection information, and controlling the output of the visual information based on the detection information. With such a configuration, it is possible to control the output of the visual information based on the detection information by sensor 18, for example, to control on or off of filtering for the display information output to display 16. For example, when it is detected that there is a third party around electronic device 10B, filtering can be set to on to prevent peeping by the third party. As a result, security can be further improved.

The control of the function related to the output of the visual information includes determining whether or not the acquisition of detection information by sensor 18 is stopped based on the position information and the security setting information, and in case of determining to stop the acquisition of detection information, stopping the acquisition of detection information by sensor 18. With such a configuration, the acquisition of detection information by sensor 18 can be stopped according to the position of electronic device 10B. As a result, power consumption of sensor 18 can be reduced. For example, in a case where electronic device 10B is in a place where security is ensured, in some cases, it is not necessary to restrict the output of the visual information. In this case, stopping of the acquisition of detection information by sensor 18 enables reduction of the power consumption of sensor 18. In addition, it is possible to prevent sensor 18 from detecting the presence of a colleague at a workplace who does not need to keep information secret and from unintentionally restricting a function when electronic device 10B is used.

Sensor 18 includes at least one of a camera, a microphone, or a proximity sensor. With such a configuration, security can be further improved.

Note that, in the present exemplary embodiment, an example has been described in which sensor 18 detects the presence of a third party, but the present invention is not limited thereto. For example, sensor 18 may detect a user who uses electronic device 10B. In this case, filtering may be set to off while sensor 18 detects the user, and filtering may be turned on while sensor 18 does not detect the user.

In the present exemplary embodiment, an example has been described in which the control of the output of the visual information is the control of on or off of filtering, but the present invention is not limited thereto. For example, the control of the output of the visual information may be control of on or off of the output of information to external output device 40.

### Other Exemplary Embodiments

For example, electronic device 10 may control a function related to output of visual information on condition of a specific place, time when accessing to a specific file or server 30, or a specific time zone.

The exemplary embodiments have been described above to exemplify the techniques disclosed in the present application. However, the technique according to the present disclosure is not limited to these exemplary embodiments, and is applicable to exemplary embodiments in which changes, replacements, additions, omissions, or the like are made as appropriate.

Although the present disclosure has been fully described with reference to a preferred exemplary embodiment and with reference to the accompanying drawings, various variations and modifications will become apparent to those skilled in the art. Such variations and modifications are to be understood as being included within the scope of the present disclosure as set forth in the appended claims, unless departing from the scope of the present disclosure.

In addition, these general and specific aspects of the present disclosure may be implemented by a system, a method, and a computer program, and combinations thereof.

### Outlines of Exemplary Embodiment

(1) An electronic device of the present disclosure includes a processor and a storage that stores an instruction to be executed by the processor, in which the instruction includes acquiring position information indicating a position of an electronic device, acquiring security setting information indicating a security setting determined according to the position of the electronic device, and controlling a function related to output of visual information of the electronic device based on the position information and the security setting information.

(2) In the electronic device according to (1), controlling the function related to the output of the visual information may include at least one of controlling on or off of filtering for display information output to a screen of the electronic device or controlling on or off of output of display information to an external output device connected to the electronic device.

(3) In the electronic device according to (1), the security setting information may include a registered position indicating a position registered in advance and a security setting set for the registered position, and controlling the function related to the output of the visual information may include determining whether or not the electronic device is at the registered position and restricting the output of the visual information according to the security setting in accordance with a determination result of whether or not the electronic device is at the registered position.

(4) In the electronic device according to (3), restricting the output of the visual information according to the security setting may include at least one of turning on filtering for display information output to a screen of the electronic device or turning off output of display information to an external output device connected to the electronic device.

(5) In the electronic device according to (3), controlling the function related to the output of the visual information may include, in accordance with a determination result of whether or not the electronic device is at the registered position, at least one of turning off filtering for display information output to a screen of the electronic device or turning on output of display information to an external output device connected to the electronic device.

(6) The electronic device according to any one of (1) to (5) may further include a sensor that acquires detection information of detecting presence of a person, and the instruction may further include acquiring the detection information by the sensor and controlling the output of the visual information based on the detection information.

(7) In the electronic device according to (6), controlling the function related to the output of the visual information may include determining whether or not acquisition of the detection information by the sensor is stopped based on the position information and the security setting information and stopping the acquisition of the detection information by the sensor in a case where it is determined to stop the acquisition of the detection information.

(8) In the electronic device according to (6) or (7), the sensor may include at least one of a camera, a microphone, a proximity sensor, an infrared sensor, or an ultrasonic sensor.

(9) The electronic device according to any one of (1) to (8) may further include a first communication unit that communicates with an external device that acquires the position information, and acquiring the position information may include acquiring the position information from the external device by the first communication unit.

(10) The electronic device according to any one of (1) to (9) may further include a position information detector that acquires the position information of the electronic device, and
acquiring the position information may include acquiring the position information by the position information detector.

(11) In the electronic device according to any one of (1) to (10), the security setting information may be stored in a server on a network, the electronic device may further include a second communication unit that communicates with the server via the network, and the instruction may include acquiring the security setting information from the server by the second communication unit.

(12) In the electronic device according to any one of (1) to (11), the instruction may further include notifying information regarding control of the function related to the output of the visual information.

(13) A method for controlling an electronic device of the present disclosure includes acquiring position information indicating a position of an electronic device, acquiring security setting information indicating a security setting determined according to the position of the electronic device, and controlling a function related to output of visual information of the electronic device based on the position information and the security setting information.

(14) A program of the present disclosure executes the control method according to (13).

(15) A computer readable storage medium of the present disclosure stores the program according to (14).

### INDUSTRIAL APPLICABILITY

The present disclosure can be applied to an electronic device that controls a function related to output of visual information according to a position of the electronic device.

### REFERENCE MARKS IN THE DRAWINGS

1, 1A, 1B control system
10, 10A, 10B electronic device
11 processor
12 storage
13 first communication unit
14 second communication unit
15 position information detector
16 display
17 external output port
20 external device
30 server
40 external output device

1. An electronic device comprising:
a processor; and
a storage that stores an instruction to be executed by the processor,
wherein the instruction includes:
acquiring position information indicating a position of an electronic device;
acquiring security setting information indicating a security setting determined according to the position of the electronic device; and
controlling a function related to output of visual information of the electronic device based on the position information and the security setting information.

2. The electronic device according to claim 1,
wherein controlling the function related to the output of the visual information includes at least one of:
controlling on or off of filtering for display information output to a screen of the electronic device; or
controlling on or off of output of display information to an external output device connected to the electronic device.

3. The electronic device according to claim 1,
wherein the security setting information includes a registered position indicating a position registered in advance and a security setting set for the registered position, and
controlling the function related to the output of the visual information includes:
determining whether or not the electronic device is at the registered position; and
restricting the output of the visual information according to the security setting in accordance with a determination result of whether or not the electronic device is at the registered position.

4. The electronic device according to claim 3,
wherein restricting the output of the visual information according to the security setting includes at least one of:
turning on filtering for display information output to a screen of the electronic device; or
turning off output of display information to an external output device connected to the electronic device.

5. The electronic device according to claim 3,
wherein controlling the function related to the output of the visual information includes, in accordance with a determination result of whether or not the electronic device is at the registered position, at least one of:
turning off filtering for display information output to a screen of the electronic device; or
turning on output of display information to an external output device connected to the electronic device.

6. The electronic device according to claim 1, further comprising a sensor that acquires detection information of detecting presence of a person,
wherein the instruction further includes:
acquiring the detection information by the sensor; and
controlling the output of the visual information based on the detection information.

7. The electronic device according to claim 6,
wherein controlling the function related to the output of the visual information includes:
determining whether or not acquisition of the detection information by the sensor is stopped based on the position information and the security setting information; and
stopping the acquisition of the detection information by the sensor in a case where it is determined to stop the acquisition of the detection information.

8. The electronic device according to claim 6, wherein the sensor includes at least one of a camera, a microphone, a proximity sensor, an infrared sensor, or an ultrasonic sensor.

9. The electronic device according to claim 1, further comprising a first communication unit that communicates with an external device that acquires the position information,
wherein acquiring the position information includes acquiring the position information from the external device by the first communication unit.

10. The electronic device according to claim 1, further comprising a position information detector that acquires the position information of the electronic device,
wherein acquiring the position information includes acquiring the position information by the position information detector.

11. The electronic device according to claim 1,
wherein the security setting information is stored in a server on a network,
the electronic device further comprises a second communication unit that communicates with the server via the network, and
the instruction includes acquiring the security setting information from the server by the second communication unit.

12. The electronic device according to claim 1,
wherein the instruction further includes notifying information regarding control of the function related to the output of the visual information.

13. A method for controlling an electronic device, the method comprising:
acquiring position information indicating a position of an electronic device;
acquiring security setting information indicating a security setting determined according to the position of the electronic device; and
controlling a function related to output of visual information of the electronic device based on the position information and the security setting information.

14. A program for executing the method according to claim 13.

15. A computer-readable storage medium storing the program according to claim 14.
